(19) United States
(12) Patent Application Publication
(10) Pub. No.: US 2014/0043730 A1
(43) Pub. Date: Feb. 13, 2014

(54) TANTALUM CAPACITOR AND METHOD OF PREPARING THE SAME

(71) Applicants: Jae Kwang KIM, Suwon (KR); Wan Suk YANG, Suwon (KR); Hyun Sub OH, Suwon (KR)

(72) Inventors: Jae Kwang KIM, Suwon (KR); Wan Suk YANG, Suwon (KR); Hyun Sub OH, Suwon (KR)

(73) Assignee: SAMSUNG ELECTRO-MECHANICS CO., LTD., Suwon (KR)

(21) Appl. No.: 13/784,300

(22) Filed: Mar. 4, 2013

(30) Foreign Application Priority Data
Aug. 8, 2012 (KR) 10-2012-0086907

(51) Int. Cl. H01G 9/042

(52) U.S. Cl. CPC H01G 9/042
USPC 361/529; 29/25.03

(57) ABSTRACT

There is provided a tantalum capacitor including: a capacitor body containing a tantalum powder and having a tantalum wire; a molded portion surrounding the tantalum wire and the capacitor body; an anode lead frame electrically connected to the tantalum wire; an cathode lead frame including a mounting portion having the capacitor body mounted thereon and a step formed on a lower surface thereof, and an cathode terminal portion bent at the mounting portion to be closely adhered to one end surface of the molded portion; and an adhesive layer formed between the one end surface of the molded portion and the cathode terminal portion.

### CROSS-REFERENCE TO RELATED APPLICATIONS

This application claims the priority of Korean Patent Application No. 10-2012-0086907 filed on Aug. 8, 2012, in the Korean Intellectual Property Office, the disclosure of which is incorporated herein by reference.

### BACKGROUND OF THE INVENTION

1. Field of the Invention

The present invention relates to a tantalum capacitor and a method of preparing the same.

2. Description of the Related Art

Tantalum (Ta) material is a metal widely used throughout the aerospace, defense, electrical, electronic, mechanical, and chemical industries, as well as many others, due to the excellent mechanical and physical features thereof, such as a high melting point, high ductility, and corrosion-resistant properties thereof.

Tantalum has been widely used as a material for an anode of a small-sized capacitor, due to allowing for the formation of a stable anode oxide film. Recently, the amount of tantalum used annually has sharply increased by approximately 10% every year, due to the rapid development of IT industries such as the electronics and information communications industries.

A capacitor, a condenser temporarily storing electricity, is a component in which two flat electrodes, insulated to each other, are closed, and a dielectric is inserted therebetween, such that an electric charge is electrified and accumulated due to attractive force. The capacitor is used for obtaining capacitance by trapping an electric charge and an electric field in a space surrounded by two conductors.

A tantalum capacitor using the tantalum material has a structure in which a gap is generated when a tantalum powder is sintered and coagulated. Tantalum oxide (Ta₂O₅) may be formed on a surface of tantalum by an anodizing method. The formed tantalum oxide is used as a dielectric, on which a manganese dioxide (MnO₂) layer and a polymer layer are formed as electrolytes. In addition, a carbon layer and a metal layer may be formed on the manganese dioxide layer and the polymer layer to thereby form a body. In order to mount a printed circuit board (PCB), an anode lead frame and a cathode lead frame are formed on the body and a molded portion is formed thereon to complete the capacitor.

However, in the tantalum capacitor according to the related art, since the anode and cathode lead frames are required to be positioned on an upper surface or a lower surface of a product and a distance at which the anode lead frame is welded needs to be secured, an inner volume of the capacitor body may be decreased to allow capacitance to be lowered. In addition, adhesive strength between a cathode terminal and the molded portion may be weak.

The following Related Art Document discloses a solid electrolytic condenser having a porous sintered body formed of tantalum and a resin package surrounding the porous sintered body. However, the cathode terminal is conducted to a conductive member and a porous sintered body is mounted on an upper surface of the conductive member such that a configuration thereof may be relatively complicated. In addition, the document does not disclose a unit for firmly attaching a cathode terminal to a molded portion.

### RELATED ART DOCUMENT

Japanese Patent Laid-Open Publication No. JP 2008-108931

### SUMMARY OF THE INVENTION

An aspect of the present invention provides a tantalum capacitor, having increasing capacitance and improved adhesive strength with regard to a molded portion of a cathode terminal through increasing an inner volume rate to significantly increase a size of a capacitor body, while maintaining a size of a product.

According to an aspect of the present invention, there is provided a tantalum capacitor, including: a capacitor body containing a tantalum powder and having a tantalum wire; a molded portion surrounding the tantalum wire and the capacitor body; an anode lead frame electrically connected to the tantalum wire; an cathode lead frame including a mounting portion having the capacitor body mounted thereon and a step formed on a lower surface thereof, and an cathode terminal portion bent at the mounting portion to be closely adhered to one end surface of the molded portion; and an adhesive layer formed between the one end surface of the molded portion and the cathode terminal portion.

The anode lead frame may have an anode terminal portion closely adhered to the other end surface of the molded portion, and the other end surface of the molded portion and the anode terminal portion may have an adhesive layer formed therebetween.

The tantalum capacitor may further include a conductive adhesive layer formed between the lower surface of the capacitor body and the mounting portion of the cathode lead frame.

The adhesive layer may contain an epoxy-based thermosetting resin.

The anode terminal portion and the cathode terminal portion may respectively have an area of 30% or more based on one end surface of the molded portion.

According to another aspect of the present invention, there is provided a method of preparing a tantalum capacitor, the method including: preparing flat-type anode and cathode lead frames; forming a tantalum wire contact part by vertically bending one end portion of the anode lead frame, and forming a step on a lower surface of the cathode lead frame; horizontally disposing the anode and cathode lead frames so as to face each other; mounting a capacitor body on an upper surface of one end portion of the cathode lead frame, and attaching a tantalum wire of the capacitor body to the tantalum wire connection portion of the anode lead frame; forming a molded portion by molding a resin to surround the tantalum wire and the capacitor body so that the end portions of the anode and cathode lead frames are exposed, respectively; and attaching the exposed end portion of the cathode lead frame to one end surface of the molded portion by applying an adhesive to the exposed end portion of the cathode lead frame and bending the exposed end portion, and attaching the end portion of the anode lead frame to the other end surface of the molded portion by bending the exposed end portion of the anode lead frame.

The method may further include, before the bending of the exposed end portion of the anode lead frame, applying the adhesive to the exposed end portion of the anode lead frame.

The method may further include, before the mounting of the capacitor body, applying a conductive adhesive to an upper surface of the one end portion of the cathode lead frame.

The method may further include, before the mounting of the capacitor body, attaching heat-resistant tape to lower surfaces of the anode and cathode lead frames, and after the forming of the molded portion, removing the heat-resistant tape.

In the preparing of the flat-type anode lead frame, the anode lead frame may have two grooves for bending formed on the upper surface thereof so as to be bent to configure the tantalum wire contact part connected to the tantalum wire, the anode terminal portion attached on the other end surface of the molded portion, and a connection portion supporting the tantalum wire contact part and the anode terminal portion.

In the preparing of the flat-type cathode lead frame, the cathode lead frame may have a groove for bending formed on the upper surface thereof so as to be bent to configure an cathode terminal portion attached to one end surface of the molded portion.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a transparent perspective view showing a schematic structure of a tantalum capacitor according to an embodiment of the present invention;

FIG. 2 is a cross-sectional view taken along line A-A′ of FIG. 1;

FIG. 3 is a cross-sectional view taken along line B-B′ of FIG. 1;

FIGS. 4A through 4G are cross-sectional views showing a process of preparing the tantalum capacitor according to the embodiment of the present invention;

FIG. 5 is a cross-sectional view showing an anode lead frame of a tantalum capacitor according to another embodiment of the present invention; and

FIG. 6 is a cross-sectional view showing a cathode lead frame of a tantalum capacitor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

In addition, in the present embodiment, for convenience of explanation, a surface from which a tantalum wire is led from a molded portion is a front side and an end surface, surfaces vertically intersecting end surfaces are side surfaces, and surfaces in a thickness direction of a capacitor body are an upper surface and a lower surface.

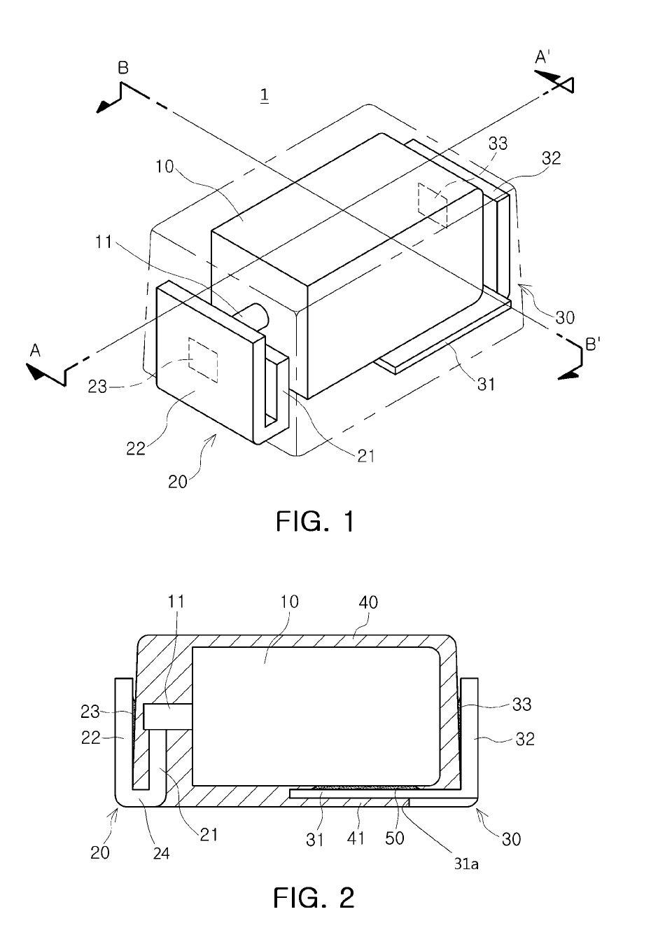

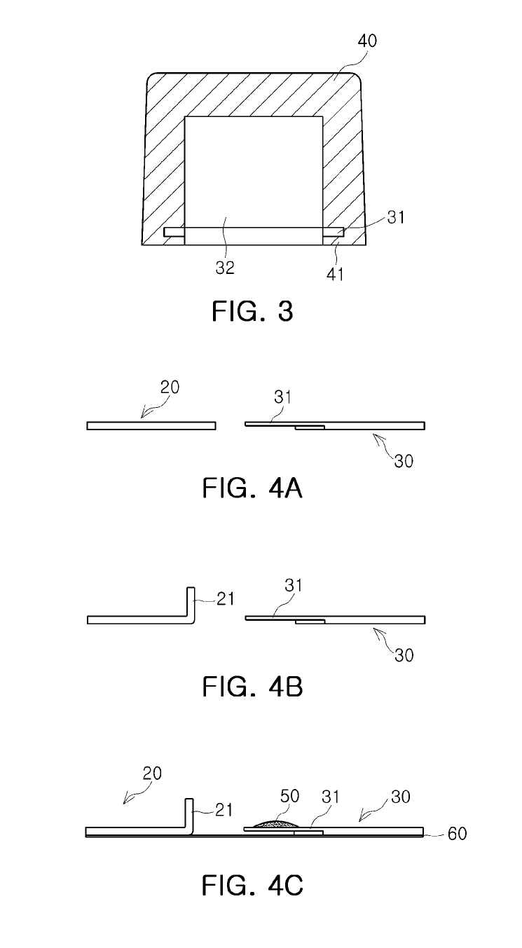

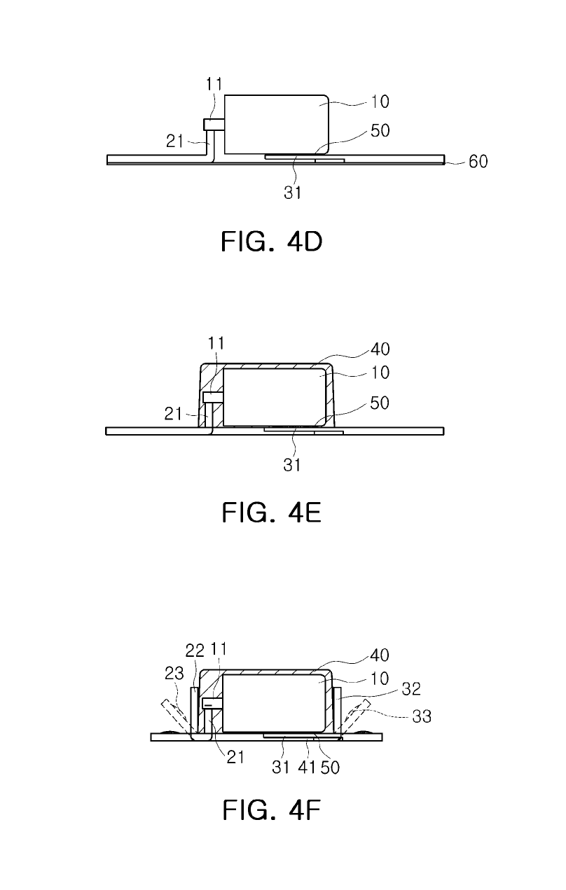

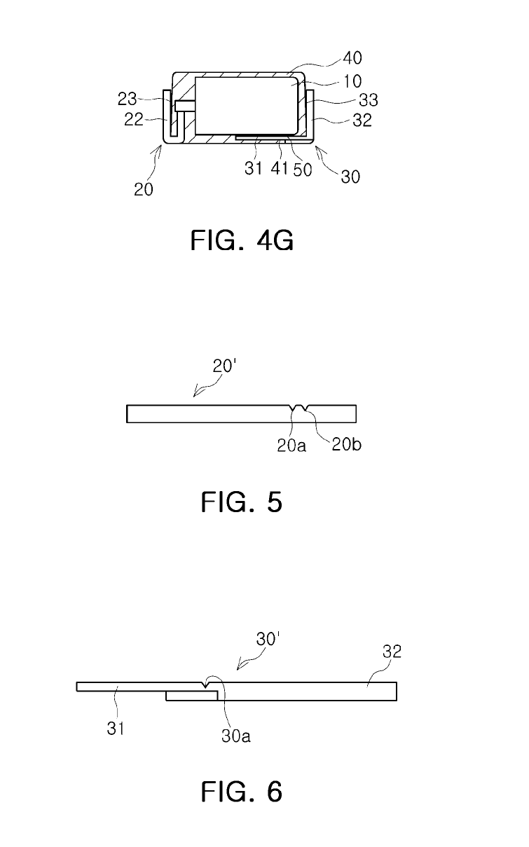

Referring to FIGS. 1 through 3, a tantalum capacitor 1 according to an embodiment of the present invention may include a capacitor body 10 containing a tantalum powder and having a tantalum wire 11 led outward from the front side; a molded portion 40 surrounding the tantalum wire 11 and the capacitor body 10; an anode lead frame 20 electrically connected to the tantalum wire 11; an cathode lead frame 30 including a mounting portion 31 having the capacitor body 10 mounted thereon and a step 31a formed on a lower surface thereof, and an cathode terminal portion 32 being bent upwardly from the mounting portion 31 to be closely adhered to one end surface of the molded portion 40; and an adhesive layer 33 formed between the rear side surface of the molded portion 40 and the cathode terminal portion 32.

The adhesive layer 33 formed between the rear side surface of the molded portion 40 and the cathode terminal portion 32 may be formed of an adhesive containing an epoxy-based thermosetting resin. However, the present invention is not limited thereto.

The capacitor body 10 may be molded by a sintering process using a tantalum material.

In the case of preparing the capacitor body 10 by using the tantalum material, the tantalum powder and a binder are mixed in a predetermined ratio and agitated. After compressing the mixed powder and molding it as a rectangular parallelepiped, the sintering process is performed under high temperature and high vibrations to prepare the capacitor body.

Here, the tantalum wire 11 may be installed by being inserted so as to be eccentric from the center before compressing the mixed powder.

Specifically, the capacitor body 10 may be prepared by inserting the tantalum wire 11 into the tantalum powder mixed with the binder, molding the tantalum device having a necessary size, and sintering the tantalum device under a temperature of about 1000 to 2000° C. and high degree of vacuum of 10⁻⁵ torr or less for about 30 minutes.

In addition, carbon and silver (Ag) are applied to a surface of the capacitor body 10. The carbon allows contact resistance of the surface of the capacitor body 10 to be reduced, and the silver (Ag) allows the cathode to be led out.

The anode lead frame 20 may be formed of a conductive metal, and may include a tantalum wire contact part 21 provided in the molded portion 40 and positioned at an end portion of the rear side bent upwardly so as to be in contact with the tantalum wire 11, an anode terminal portion 22 being bent upwardly so as to be closely adhered to the front side surface of the molded portion 40, and a connection portion 24 connecting the upwardly bent tantalum wire contact part 21 and anode terminal portion 22 to each other.

The tantalum wire contact part 21 may be attached by electric welding; in particular, the welding may be performed by using an electric spot welding method. However, the present invention is not limited thereto.

In this case, since the tantalum wire contact part 21 is in contact with a lower side of the tantalum wire 11, a distance required for the welding may be decreased as compared to a structure according to the related art in which the connector is extended from a side surface of a molded portion to be in contact.

In addition, the anode terminal portion 22 may be used as a terminal for forming an electrical connection with other electrical products. Since the anode terminal portion 22 is formed on the end surface of the molded portion 40, volumetric efficiency of the capacitor body 10 may be improved as compared to that of the related art having lead terminals formed in the upper and lower portions of the product.

The anode terminal portion 22 may cover an area of at least 30% or more based on one end surface of the molded portion 40.

In addition, an adhesive layer 23 may be formed between the anode terminal portion 22 of the anode lead frame 20 and the end surface of the molded portion 40. The adhesive layer 23 may be formed of an adhesive having the same material as the adhesive layer 33 formed at the cathode terminal portion 32.

The cathode lead frame 30 may be formed of a conductive metal and may include manganese, a polymer, or the like. However, the present invention is not limited thereto.

A step 31a formed on a lower surface of the mounting portion 31 of the cathode lead frame 30 may be jointed with a mold joint part 41 of the molded portion 40 in an insertion manner, such that adhesive strength thereof may be improved.

In addition, the cathode terminal portion 32 may be used as a terminal for forming an electrical connection with other electrical products. Since the cathode terminal portion 32 is formed on the end surface of the molded portion 40, volumetric efficiency of the capacitor body 10 may be improved as compared to that of the related art having lead terminals formed in the upper and lower portions of the product.

The cathode terminal portion 32 may cover an area of at least 30% or more based on one end surface of the molded portion 40.

Meanwhile, a conductive adhesive layer 50 may further be formed between the upper surface of the mounting portion 31 of the cathode lead frame 30 and the lower surface of the mounted capacitor body 10. The conductive adhesive layer 50 may be formed of an adhesive further containing a conductive metal powder, or the like, to the adhesive layer 33 formed at the cathode terminal portion 32. However, the present invention is not limited thereto. Here, the conductive metal powder may be silver (Ag). However, the present invention is not limited thereto.

In general, in the tantalum capacitor structure, as the volume of the capacitor body 10 is increased, the capacitance of the capacitor is increased. However, since physical volume is increased, there is a limitation in significantly reducing the size of devices.

In the present embodiments, the terminals of the anode and cathode lead frames are formed on the end surfaces of the product, such that the inner volume rate is improved to significantly increase a size of the capacitor body as compared to a tantalum capacitor according to the related art in which anode and cathode lead frames are positioned on upper or lower portions, whereby a size of the product may be maintained and the capacitance may be increased.

Hereinafter, a method of preparing of the tantalum capacitor 1 according to the embodiment of the present invention will be described.

First, flat-type anode and cathode lead frames 20 and 30 are prepared.

Here, in the anode lead frame 20, a tantalum wire contact part 21 electrically connected to a tantalum wire 11, formed by bending the end portion of the rear side of the anode lead frame 20 upwardly to be vertical, is formed. In addition, in the cathode lead frame 30, a step 31a is formed on a lower surface thereof by using an etching method, a press mold method, or the like.

Then, the anode and cathode lead frames 20 and 30 are horizontally disposed to face each other.

Here, heat-resistant tape 60 is attached to lower surfaces of the anode and cathode lead frames so as to connect the anode and cathode lead frames to each other. The heat-resistant tape 60 prevents surfaces of the cathode and anode lead frames 20 and 30 from being contaminated in a molding process to be subsequently progressed.

Then, the capacitor body 10 is mounted on the upper surface of an end portion of the front side of the cathode lead frame 30. The part at which the capacitor body 10 is mounted refers to the mounting portion 31 as mentioned above.

In addition, in the state in which the tantalum wire 11 of the capacitor body 10 contacts the tantalum wire contact part 21 of the anode lead frame 20, the tantalum wire 11 is electrically attached to the tantalum wire contact part 21 by performing spot welding or a laser welding and applying the conductive adhesive.

Here, on the mounting portion 31 of the cathode lead frame 30, a conductive adhesive layer 50 having a predetermined thickness is formed by initially applying the conductive adhesive before mounting the capacitor body 10, such that adhesive strength between the cathode lead frame 30 and the capacitor body 10 may be improved. Thereafter, in order to cure the conductive adhesive layer 50, a curing process may be performed under a temperature of about 100 to 200° C.

Then, a molded portion 40 is formed by molding a resin, or the like, so as to surround the tantalum wire 11 and the capacitor body 10 except for portions exposed so that the cathode terminal portion 32 of the cathode lead frame 30 and the anode terminal portion 22 of the anode lead frame 20 are exposed to the outside. The molded portion 40 serves to protect the tantalum wire 11 and the capacitor body 10 from the outside.

At the time of completing the formation of the molded portion 40, the heat-resistant tape 60 attached on the lower surfaces of the anode and cathode lead frames 20 and 30 are removed.

Then, the conductive adhesive is applied to the cathode terminal portion 32 of the cathode lead frame 30 exposed to the outer portion of the molded portion 40, and the cathode terminal portion 32 is vertically bent upwardly to attach the rear side surface of the molded portion 40.

In addition, the anode terminal portion 22 of the anode lead frame 20 exposed to the outer portion of the molded portion 40 is vertically bent upwardly to attach the front side surface of the molded portion 40, whereby the tantalum capacitor 1 is completed. Here, before bending the anode terminal portion 22, the adhesive is applied to one surface of the anode terminal portion 22 to increase the adhesive strength with regard to the molded portion 40.

Meanwhile, before bending the anode and cathode terminal portions 22 and 32, the capacitor body 10 may be cut to an appropriate length in consideration of a size thereof, or the like.

Referring to FIG. 5, the flat-type anode lead frame 20′ may have two grooves, 20a and 20b, for bending, formed on the upper surface thereof so as to be easily bent to configure the tantalum wire contact part 21 being connected to the tantalum wire 11, the anode terminal portion 22 attached on the end surface of the molded portion 40, and a connection portion 24 supporting the tantalum wire contact part 21 and the anode terminal portion 22.

That is, two grooves 20a and 20b for bending alleviate impacts generated during bending of the tantalum wire contact part 21 and the anode terminal portion 22 to prevent the anode lead frame 20′ from being bent or deformed.

Referring to FIG. 6, a groove 30a for bending may be formed on the upper surface of the flat-type cathode lead frame 30′. The groove 30a for bending alleviates impacts generated during the bending of the cathode terminal portion 32 to prevent the cathode lead frame 30′ from being bent or deformed.

As set forth above, according to the embodiment of the present invention, the anode and cathode lead frames are formed on both end surfaces of the product to improve the inner volume rate, whereby the size of the capacitor body may be significantly increased while maintaining the size of the product to increase the capacitance.

In addition, the cathode lead frame is led from the lower surface of the product and has the step being jointed with the molded portion on the mounting portion, and the cathode terminal portion exposed to the outside of the cathode lead frame is attached on one end surface of the molded portion by an adhesive, whereby the adhesive strength may be improved.

While the present invention has been shown and described in connection with the embodiments, it will be apparent to those skilled in the art that modifications and variations can be made without departing from the spirit and scope of the invention as defined by the appended claims.

What is claimed is:

1. A tantalum capacitor, comprising:
a capacitor body containing a tantalum powder and having a tantalum wire;
a molded portion surrounding the tantalum wire and the capacitor body;
an anode lead frame electrically connected to the tantalum wire;
a cathode lead frame including a mounting portion having the capacitor body mounted thereon and a step formed on a lower surface thereof, and an cathode terminal portion bent at the mounting portion to be closely adhered to one end surface of the molded portion; and
an adhesive layer formed between the one end surface of the molded portion and the cathode terminal portion.

2. The tantalum capacitor of claim 1, wherein the anode lead frame has an anode terminal portion closely adhered to the other end surface of the molded portion, and the other end surface of the molded portion and the anode terminal portion has an adhesive layer formed therebetween.

3. The tantalum capacitor of claim 1, further comprising a conductive adhesive layer formed between the lower surface of the capacitor body and the mounting portion of the cathode lead frame.

4. The tantalum capacitor of claim 1, wherein the adhesive layer contains an epoxy-based thermosetting resin.

5. The tantalum capacitor of claim 1, wherein the anode terminal portion and the cathode terminal portion respectively have an area of 30% or more based on one end surface of the molded portion.

6. A method of preparing a tantalum capacitor, the method comprising:
preparing flat-type anode and cathode lead frames;
forming a tantalum wire contact part by vertically bending one end portion of the anode lead frame, and forming a step on a lower surface of the cathode lead frame;
horizontally disposing the anode and cathode lead frames so as to face each other;
mounting a capacitor body on an upper surface of one end portion of the cathode lead frame, and attaching a tantalum wire of the capacitor body to the tantalum wire connection portion of the anode lead frame;
forming a molded portion by molding a resin to surround the tantalum wire and the capacitor body so as to respectively exoise the end portions of the anode and cathode lead frames; and
attaching the exposed end portion of the cathode lead frame to one end surface of the molded portion by applying an adhesive to the exposed end portion of the cathode lead frame and bending the exposed end portion, and attaching the end portion of the anode lead frame to the other end surface of the molded portion by bending the exposed end portion of the anode lead frame.

7. The method of claim 6, further comprising, before the bending of the exposed end portion of the anode lead frame, applying the adhesive to the exposed end portion of the anode lead frame.

8. The method of claim 6, further comprising, before the mounting of the capacitor body, applying a conductive adhesive to an upper surface of the one end portion of the cathode lead frame.

9. The method of claim 6, further comprising, before the mounting of the capacitor body, attaching heat-resistant tape to lower surfaces of the anode and cathode lead frames, and after the forming of the molded portion, removing the heat-resistant tape.

10. The method of claim 6, wherein in the attaching of the exposed end portion of the cathode lead frame to one end surface of the molded portion by applying the adhesive on the exposed end portion of the cathode lead frame and bending the exposed end portion, the adhesive contains an epoxy-based thermosetting resin.

11. The method of claim 6, wherein in the preparing of the flat-type anode lead frame, the anode lead frame has two grooves for bending formed on the upper surface thereof so as to be bent to configure the tantalum wire contact part connected to the tantalum wire, the anode terminal portion attached on the other end surface of the molded portion, and a connection portion supporting the tantalum wire contact part and the anode terminal portion.

12. The method of claim 6, wherein in the preparing of the flat-type cathode lead frame, the cathode lead frame has a groove for bending formed on the upper surface thereof so as to be bent to configure an cathode terminal portion attached to one end surface of the molded portion.
